(19) United States
(12) Patent Application Publication
(10) Pub. No.: US 2015/0149299 A1
(43) Pub. Date: May 28, 2015

(54) System and Method for Providing Relevant Advocate Endorsements in Digital Media

(71) Applicant: Robert G. Fuggetta, Burlingame, CA (US)

(72) Inventor: Robert G. Fuggetta, Burlingame, CA (US)

(21) Appl. No.: 14/553,969

(22) Filed: Nov. 25, 2014

Related U.S. Application Data
(60) Provisional application No. 61/909,993, filed on Nov. 27, 2013.

(51) Int. Cl. G06Q 30/02

(52) U.S. Cl. CPC G06Q 30/0269
USPC 705/14.66

(57) ABSTRACT

A system and method are disclosed for displaying relevant advocate endorsements in paid or other digital media.

### CROSS-REFERENCE TO RELATED APPLICATION

This application claims the benefit of priority under 35 U.S.C. 119(e) to U.S. Provisional Patent Application No. 61/909,993, entitled “System and Method for Providing Relevant Advocate Endorsements in Digital Media,” filed on Nov. 27, 2013, the entire contents of which are incorporated herein by reference.

### TECHNICAL FIELD

This disclosure relates generally to advertising in digital media.

### BACKGROUND

A “brand advocate” is a term used in electronic commerce and online advertising to describe a person or customer who talks favorably about a brand or product and then passes on positive word-of-mouth messages about the brand to other people. Brand advocates are more influential than an average customer. Often a positive experience with a brand or successful customer-service relationship motivates a brand advocate to express their positive feelings towards a brand to other potential customers. A brand advocate performs functions higher than that of a testimonial and much lower than that of a promotional model or brand ambassador, since brand advocacy implies active participation with the brand involved. Social media tools allow a brand advocate to recommend brands on websites, social networks, blogs and other online forums.

### SUMMARY

A system and method are disclosed for providing relevant endorsements in paid or other digital media.

In some implementations, a method of providing relevant endorsements in paid or other digital media generally includes three steps. In step one, the consumer clicks on an online ad (e.g., banner ad, paid search ad), a marketing email, a banner or link on a brand's website or other content online. The consumer may be using a computer, smart phone, or any device that accesses content online.

In step two, an advocate ad system “recognizes” the consumer. This can be accomplished via an HTTP cookie, a small piece of data sent from a website and stored in a user's web browser, that has previously been installed on the consumer's web browser. The system also may recognize the consumer if the consumer voluntarily provides profile information about himself/herself such as a zip code of where the consumer resides, their current location, area code, gender, hobbies or other information.

In some implementations, the consumer can be “recognized” by using known customer analytic models/tools, statistical models (e.g., predictive models, segmentation or clustering algorithms), artificial intelligence or any other known model or process that can be used to recognize the consumer. For example, if a consumer opts into allowing the consumer's behavior data to be shared with the system, then the consumer's actions (historical or current) performed on their device, such as web surfing, content downloads, current and past locations, preferred language, online transaction information can be stored in cache on the consumer device and transmitted to a system server for processing by a customer analytics tool, model or process.

In step three, the system automatically provides an endorsement created by an advocate who has a positive opinion of the company, product, or service. The endorsement is “relevant” in that the endorsement is from the advocate with whom the consumer feels some affiliation. This may be a friend, peer, colleague, or other person who has a similar profile or who shares some similar characteristics with the consumer. For example, a consumer interested in buying a digital video recorder (DVR) and who searches on the term “DVRs” would see a banner ad sponsored by a DVR manufacturer. This banner ad would feature endorsements for the manufacturer's product from advocates who share similar characteristics with the consumer, such as they reside in the same zip code as the consumer.

Advocate endorsements can be delivered or presented to the consumer in a variety of digital media including but not limited to: web pages (e.g., landing pages), visual ads (e.g., banner ads), marketing emails and texts, blogs, links, audio recordings and video. In implementations where the consumer is using a location aware device, the user's location (e.g., GPS coordinates) can be used to obtain relevant advocate endorsements. The location can be determined using any known positioning technology, including but not limited to: satellite-based (e.g., GPS) and network-based (e.g., Wi-Fi, cellular, Bluetooth) positioning systems.

Throughout the process described above, the advocate ad system tracks and analyzes results, such as whether the consumer clicked to view the ad unit featuring advocate content (e.g., a written or audio endorsement), whether the consumer clicked on a promotional offer included with the advocate content and whether the consumer purchased a product or service associated with the promotional offer.

In some implementations, the system for providing relevant endorsements in paid or other digital media includes one or more databases which store profile and other information about brand advocates, a content management system which obtains and stores advocate endorsements, an ad server that serves advocate endorsements to consumers, an analytics module for tracking and analyzing results and a recognition engine that recognizes the consumer and provides relevant advocate endorsements to the consumer.

The details of the disclosed implementations are set forth in the accompanying drawings and the description below. Other features, objects and advantages are apparent from the description, drawings and claims.

### DESCRIPTION OF DRAWINGS

FIG. 1 illustrates the principal functions of an example advocate ad system.

FIG. 2 illustrates an example process for providing relevant advocate endorsements in digital media.

FIG. 3 is a block diagram of an example advocate ad system.

The same reference symbol used in various drawings indicates like elements.

### DETAILED DESCRIPTION

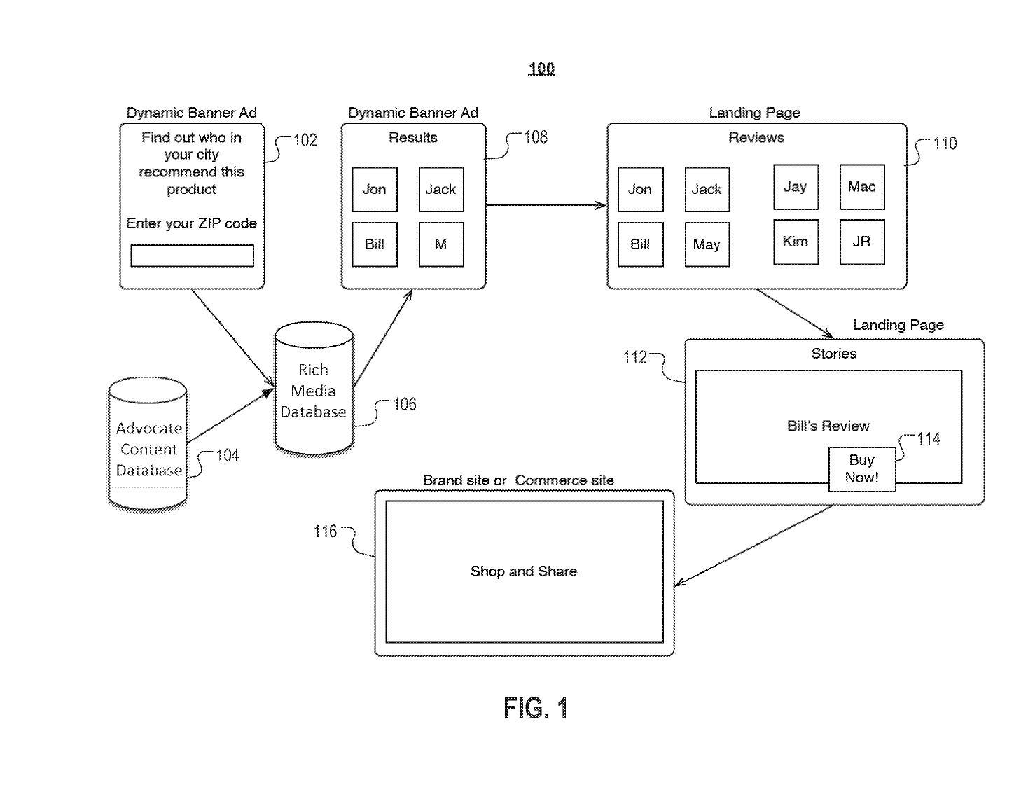

FIG. 1 illustrates the principal functions of an example advocate ad system 100. An ad 102 (e.g., a dynamic banner ad) is delivered to a consumer through digital media (e.g., webpage, marketing email). For example, a dynamic banner ad can be presented on a webpage that the consumer is viewing in a web browser on a mobile device (e.g., a smart phone, e-tablet, wearable device, notebook computer). The dynamic banner ad is configured to receive consumer input (e.g., a text input box), such as the consumer's zip code.

Rich media units are built using the user data received through the ad 102 and advocate content (e.g., endorsements) stored in an advocate content database 104. The rich media units can be stored in a rich media database 106. The rich media units can be delivered to the consumer using the ad 108, which in this example can be the same dynamic banner ad or different digital media.

When the consumer clicks on a media unit presented by ad 108, the consumer is directed to a landing web page 110 by the web browser using a URL for the landing web page 110. The landing web page 110 presents user-selectable advocate content, including reviews or endorsements by advocates who share a common characteristic with the consumer or have a profile that is similar to the consumer's profile. Some examples of common characteristics include but are not limited to: the advocate resides in the same zip code as the consumer, the advocate has a profile similar to the consumer's profile, the advocate has a similar demographic (e.g., age, gender) as the consumer, the advocate has similar likes or dislikes as the consumer (e.g., Facebook® likes or dislikes) and the advocate having similar hobbies or interests as the consumer.

In some implementations, buying criteria can be a common characteristic that is shared between the consumer and the advocate. For example, the consumer and advocate may both be interested in similar buying criteria such as price, value or features. Those consumers will be provided with advocate endorsements for value deals, luxury items, bulk purchases, etc. In some implementations, a common characteristic can be the buying solution. For example, the consumer may be looking for a service that requires a specific skill set (e.g., patent lawyer, plumber). In some implementations, a common characteristic can be the buying stage of the consumer. For example, a consumer in a product review or demonstration stage of purchasing a product or service can be provided endorsements that are relevant to the consumer's current stage of buying.

When the consumer selects advocate content for review (e.g., by clicking or touching), the consumer is directed (e.g., by the web browser using a URL) to a landing web page 112, where the consumer is presented with the selected advocate content. An advocate can be an individual or an organization. In the example shown, the consumer selected Bill and was presented with a review and/or endorsement of a particular company, product or service by Bill. A link 114 to buy the product or service can also be included in the landing page 112. When the consumer selects the link 114, the consumer is directed to branded or commerce website 116, where a purchase of the product or service can be made by the consumer. In some implementations, the consumer can be asked to rate the endorsement as being helpful or not helpful, and such rating can be used by the system to manage advocate content.

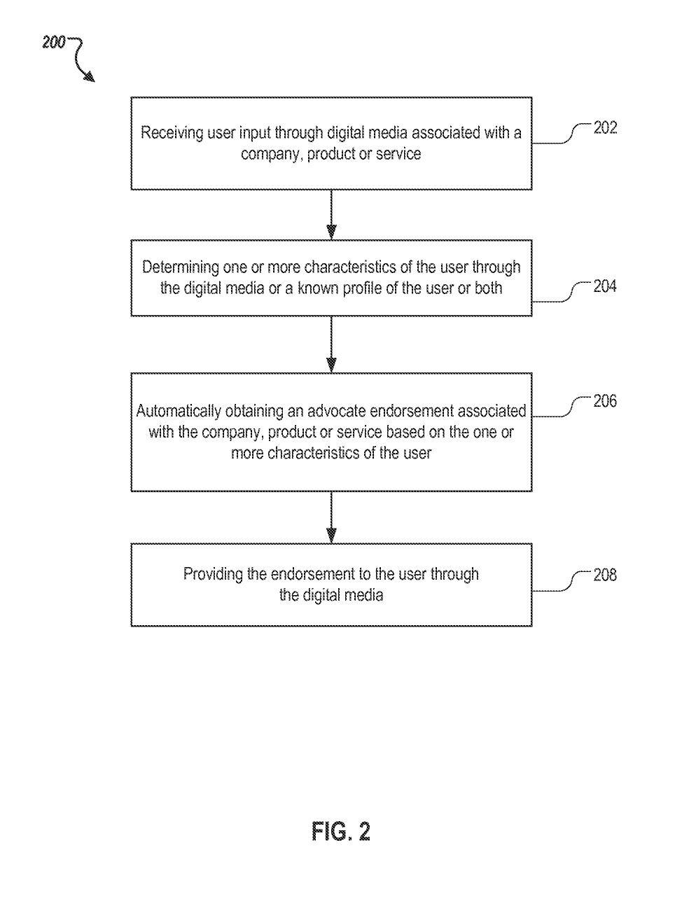

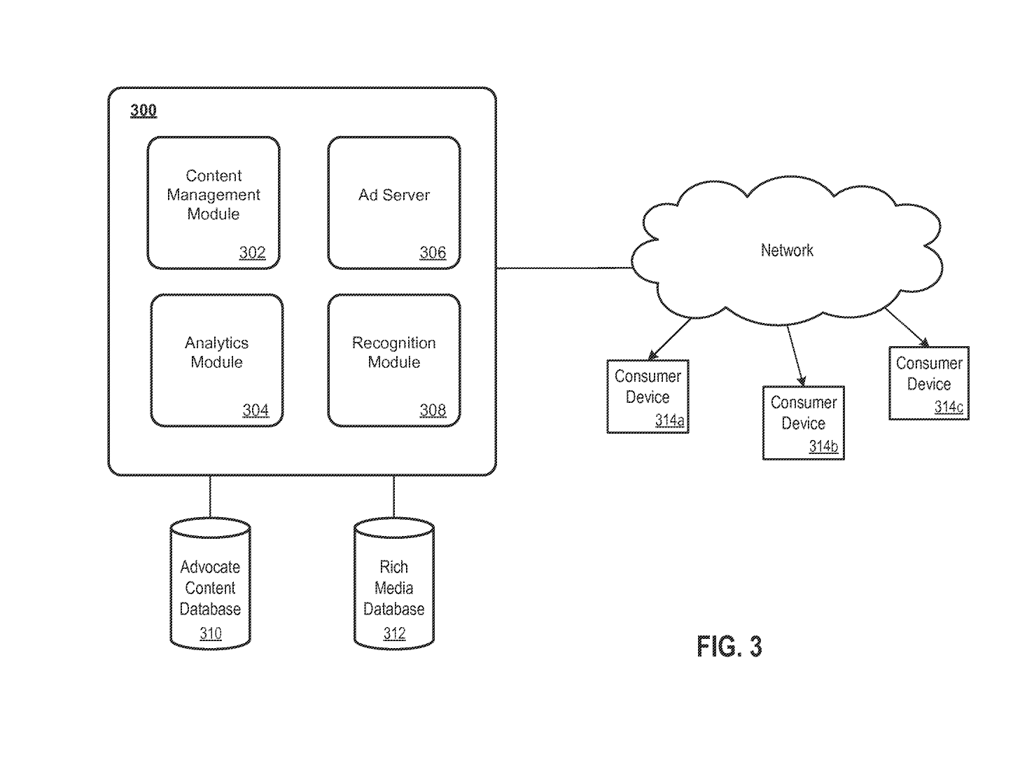

FIG. 2 illustrates an example process 200 for providing relevant advocate endorsements in digital media. Process 200 can be implemented by the advocate ad system described in reference to FIG. 3.

In some implementations, process 200 can begin by receiving user input through digital media associated with a company, product or service (202), determining one or more characteristics of the user through the digital media or a known profile of the user or both (204); automatically obtaining an advocate endorsement associated with the company, product or service based on the one or more characteristics of the user (206); and providing the endorsement to the user through the digital media. In some implementations the digital media is configured to direct the user to an online resource associated with the company, product or service (208), such as a landing web page.

FIG. 3 is a block diagram of an example advocate ad system 300. In some implementations, system 300 can include content management module 302, analytics module 304, ad server 306 and recognition module 308. Coupled to advocate ad system 300 is advocate content database 310 and rich media database 312. Various components of advocate ad system 300 can be implemented on one or more server computers coupled to a wide area network (e.g., Internet) or other network that is coupled (wired or wirelessly) to multiple consumer devices (e.g., smart phone, e-tablet, wearable device, notebook computer, television system, kiosk) either directly or through a local area network (e.g., Wi-Fi, cellular, Bluetooth). Databases 310 and 312 can be implanted as a single database or several databases.

Content management module 302 is configured to obtain and store advocate endorsements. Analytics module 304 is configured to track and analyze results, such as a click-through rate for an ad, conversion rates and other metrics used to determine the success of a particular ad or ad campaign. Ad server 306 is configured to serve advocate endorsements to consumers. Recognition module 310 is configured to recognize the consumer and provide relevant advocate endorsements to consumers. The consumer can be recognized through an HTTP cookie or profile information provided by the consumer, such as the zip code of where the consumer resides, the consumer's current location; area code, gender, hobbies or interests, likes or dislikes or any other information that can be used to recognize the consumer.

Advocate content database 310 stores advocate content such as endorsements. Rich media database 312 stores digital media units that have been enriched by the advocate information, such as a dynamic banner add that includes a link to a landing page with one or more advocate endorsements.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method of providing relevant endorsements in digital media, the method comprising:
receiving user input through digital media associated with a company, product or service;
determining one or more characteristics of the user through at least one of the digital media or a known user profile;
automatically obtaining an advocate endorsement associated with the company, product or service based on the one or more characteristics of the user; and
providing the advocate endorsement to the user through the digital media, where the method is performed by one or more hardware processors.

2. The method of claim 1, wherein the digital media is configured to direct the user to an online resource associated with the company, product or service.

3. The method of claim 1, where providing the endorsement to the user through the digital media includes providing an audio endorsement.

4. The method of claim 1, where the user input is one or more voice commands.

5. The method of claim 1, where the digital media is a banner ad.

6. The method of claim 1, were automatically obtaining an advocate endorsement associated with the company, product or service based on the one or more characteristics of the user further comprises:
comparing the one or more characteristics of the user with an advocate profile; and
selecting an advocate endorsement based on results of the comparing.

7. The method of claim 6, further comprising:
tracking or analyzing the user's response to the advocate endorsement.

8. The method of claim 7, where tracking or analyzing the user's response includes determining if the user clicked or touched on a promotional offer included with the endorsement in the digital media presented to the user or whether the user purchased a product or service using the promotional offer.

9. An advocate ad system comprises:
a content management module configured to obtain and store advocate content;
a recognition module configured to automatically obtain an advocate endorsement associated with a company, product or service based on one or more characteristics of a user that are similar to an advocate; and
an ad server for delivering the advocate content to the user.
